(19) United States
(12) Patent Application Publication
(10) Pub. No.: US 2025/0307710 A1
(43) Pub. Date: Oct. 2, 2025

(54) METHOD OF RECOMMENDING PROCESS RECIPE AND TRAINING METHOD OF PROCESS RESULT PREDICTOR

(71) Applicants: Samsung Electronics Co., Ltd., Suwon-si (KR); Korea Advanced Institute of Science and Technology, Daejeon (KR)

(72) Inventors: Taewook NAM, Daejeon (KR); Sung Ju HWANG, Daejeon (KR); Hamin KOO, Daejeon (KR)

(73) Assignees: Samsung Electronics Co., Ltd., Suwon-si (KR); Korea Advanced Institute of Science and Technology, Daejeon (KR)

(21) Appl. No.: 19/094,047

(22) Filed: Mar. 28, 2025

(30) Foreign Application Priority Data
Mar. 28, 2024 (KR) 10-2024-0042648

(51) Int. Cl. G06N 20/00

(52) U.S. Cl. CPC G06N 20/00

(57) ABSTRACT

A method of recommending a process recipe is provided. The method includes selecting candidate process recipes for material synthesis corresponding to target physical properties based on a prediction result of a pre-trained process result predictor based on pieces of recipe data corresponding to a target process, collecting preference data of an expert for arbitrary process recipe pairs selected from among the candidate process recipes, training a preference predictor to predict preference of the expert for the arbitrary process recipe pairs, using the preference data, and recommending, among the candidate process recipes, a target process recipe for the target process, based on the target physical properties predicted by the pre-trained process result predictor and a preference prediction value predicted by the preference predictor in response to the candidate process recipes.

### CROSS-REFERENCE TO RELATED APPLICATIONS

This application claims the benefit under 35 USC § 119(a) of Korean Patent Application No. 10-2024-0042648, filed on Mar. 28, 2024, in the Korean Intellectual Property Office, the entire disclosure of which is incorporated herein by reference for all purposes.

### BACKGROUND

### 1. Field

The following description relates to a method of recommending a process recipe and a training method of a process result predictor.

### 2. Description of Related Art

Optimization of a target process, such as a thin film deposition process, may involve searching for physical conditions such as pressure, temperature, and time-of-optimal-deposition for equipment for which target physical properties may be synthesized. When optimizing such a process, there may be a limitation in collecting large amounts of data because significant time, expense, and manpower are required to test the result of arbitrary process conditions. In addition, a search interval of a condition for a testable process is very wide, but an actual physically-meaningful interval may be limited. This may be overcome by repeating a process of determining a search condition for a process through an experiment formulated by an expert who has a good understanding of physical aspects of the process and which reflects a result back to the expert's experience.

When optimizing a search condition by the preference of a human expert, there may be a strength in generalization through overall trend analysis and inference of data, but detailed numerical optimization is difficult, and it may not be easy to identify a new multidimensional or nonlinear correlation on the data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, a method of recommending a process recipe includes selecting candidate process recipes for material synthesis corresponding to target physical properties based on a prediction result of a pre-trained process result predictor based on pieces of recipe data corresponding to a target process, collecting preference data of an expert for arbitrary process recipe pairs selected from among the candidate process recipes, training a preference predictor to predict preference of the expert for the arbitrary process recipe pairs, using the preference data, and recommending, among the candidate process recipes, a target process recipe for the target process, based on the target physical properties predicted by the pre-trained process result predictor and based on a preference prediction value predicted by the preference predictor in response to the candidate process recipes.

The process result predictor may include a trained physical property prediction model to predict the target physical properties corresponding to the candidate process recipes, based on the pieces of recipe data.

The collecting of the preference data of the expert may include selecting the arbitrary process recipe pairs from process recipes having target physical properties above a predetermined reference according to the prediction result of the pre-trained process result predictor in an entire search interval of the candidate process recipes and collecting the preference data of the expert based on the selected arbitrary process recipe pairs.

The selecting of the arbitrary process recipe pairs may include filtering candidate process recipes predicted to have a score that is higher than a predetermined reference in the entire search interval corresponding to the target physical properties predicted by the pre-trained process result predictor and sampling the selected arbitrary process recipe pairs from among the filtered candidate process recipes.

The collecting of the preference data of the expert may include collecting, among the selected arbitrary process recipe pairs, one process recipe selected by the expert as the preference data.

The target process may include a thin film deposition process.

The recommending of the target process recipe may include specifying search intervals of the process recipe by considering a valid interval of the target physical properties and process parameters, excluding a constraint area corresponding to a predetermined condition in an entire search interval of the candidate process recipes, based on data distribution and a normalization range of the process parameters corresponding to the search intervals of the process recipe, and determining the target process recipe based on remaining search intervals other than the constraint area in the entire search interval.

The recommending of the target process recipe may include determining the target process recipe based on a score function that indicates a degree to which the target physical properties match physical properties predicted for each label by the pre-trained process result predictor.

The determining of the target process recipe may include converting a degree to which each of physical property numerical values predicted by the pre-trained process result predictor is close to a numerical value of the target physical properties into quality scores, using the score function, and determining the target process recipe based on the converted quality scores.

The recommending of the target process recipe may include adjusting a reflection ratio between the target physical properties and the preference prediction value and recommending, among the candidate process recipes, the target process recipe for the target process according to the adjusted reflection ratio.

The pieces of recipe data may include at least one of process conditions including a catalyst and a wafer size or process parameters that are sequentially controlled during the target process.

The process conditions may have a predetermined search interval and may include a plurality of detailed conditions having two or more valid categories.

In another general aspect, a training method of a process result predictor includes preprocessing pieces of recipe data received to train the process result predictor and training the process result predictor using the pieces of preprocessed recipe data.

The preprocessing of the pieces of recipe data may include filtering, from among the pieces of recipe data, at least one of recipe data having a valid physical property numerical value or recipe data in an unstandardized form.

The preprocessing of the pieces of recipe data may include quantifying and normalizing, in a vector form, a process and physical properties corresponding to the pieces of recipe data.

The preprocessing of the pieces of recipe data may include quantifying the pieces of recipe data in a vector form by tokenizing the pieces of recipe data into identifiers for each process condition.

The training of the process result predictor may include training, among the preprocessed pieces of recipe data, the process result predictor by inputting process parameters used in a control process of a material synthesis environment to the process result predictor.

The training of the process result predictor may include training the process result predictor to predict a range expected for each physical property numerical value as normal distribution to predict physical property numerical values measured at various locations for each process recipe.

The training of the process result predictor may include training the process result predictor using maximum likelihood loss for output normal distribution of the process result predictor.

In still another general aspect, an apparatus for recommending a process recipe includes one or more processors and a memory storing instructions configured to cause the one or more processors to: select candidate process recipes for material synthesis corresponding to target physical properties based on a prediction result of a pre-trained process result predictor based on pieces of recipe data corresponding to a target process, collect preference data of an expert for arbitrary process recipe pairs selected from among the candidate process recipes, train a preference predictor to predict preference of the expert for the arbitrary process recipe pairs, using the preference data, and recommend, among the candidate process recipes, a target process recipe for the target process, based on the target physical properties predicted by the pre-trained process result predictor and a preference prediction value predicted by the preference predictor in response to the candidate process recipes.

Other features and aspects will be apparent from the following detailed description, the drawings, and the claims.

### BRIEF DESCRIPTION OF THE DRAWINGS

FIG. 1 illustrates an example of a method of recommending a process recipe, according to one or more embodiments.

FIG. 2 illustrates an example of a procedure of a thin film deposition process, according to one or more embodiments.

FIG. 3A illustrates an example of a standard of pieces of recipe data.

FIG. 3B illustrates an example of the main steps of a process procedure according to the type of process, according to one or more embodiments.

FIG. 3C illustrates an example of a search interval, according to one or more embodiments.

FIG. 4 illustrates an example of a method of collecting preference data, according to one or more embodiments.

FIG. 5 illustrates an example of a deep learning-based thin film deposition process optimization system, according to one or more embodiments

FIGS. 6A and 6B illustrate examples of a processing process of pieces of recipe data to train a process result predictor (e.g., a prediction model), according to one or more embodiments.

FIG. 7 illustrates an example of a training method of a process result predictor, according to one or more embodiments.

FIG. 8 illustrates an example of a method of specifying a search interval of a process recipe to be tested using a trained process result predictor, according to one or more embodiments.

FIG. 9 illustrates an example of a method of calculating quality scores using physical property numerical values predicted by a process result predictor, according to one or more embodiments.

FIG. 10 illustrates an example of a deep learning-based thin film deposition process optimization system, according to one or more embodiments.

FIGS. 11A to 11F sequentially illustrate examples of a process optimization process by considering the preference of an expert, according to one or more embodiments.

FIG. 12 illustrates an example of a method of recommending, among candidate process recipes, a target process recipe for a target process, based on target physical properties predicted by a process result predictor and a preference prediction value predicted by a preference predictor in response to the candidate process recipes, according to one or more embodiments.

FIG. 13 illustrates an example of a training method of a process result predictor, according to one or more embodiments.

FIG. 14 illustrates an example of an apparatus for recommending a process recipe, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

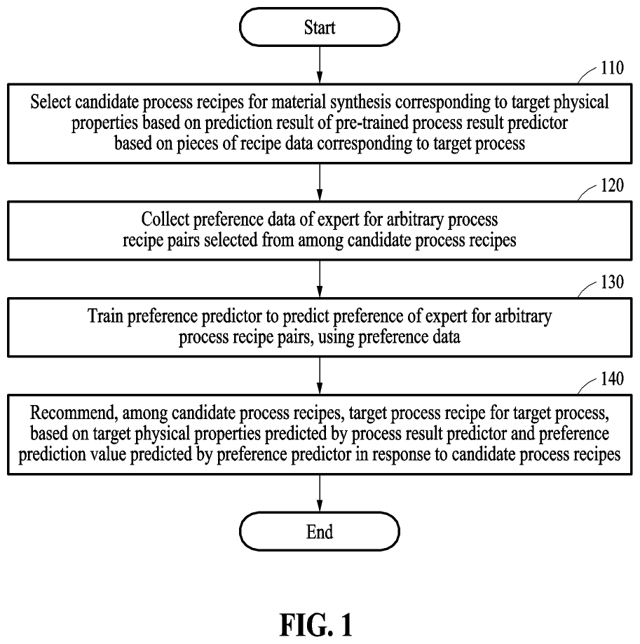

FIG. 1 illustrates an example of a method of recommending a process recipe, according to one or more embodiments.

Referring to FIG. 1, an apparatus (hereinafter, referred to as a ‘recommendation apparatus’) for recommending a process recipe may recommend a target process recipe through operations 110 to 140.

In operation 110, the recommendation apparatus may select candidate process recipes (recipes for material synthesis that corresponds to target physical properties); selection may be based on a prediction result of a pre-trained process result predictor that predicts a process result based on pieces of recipe data corresponding to a target process.

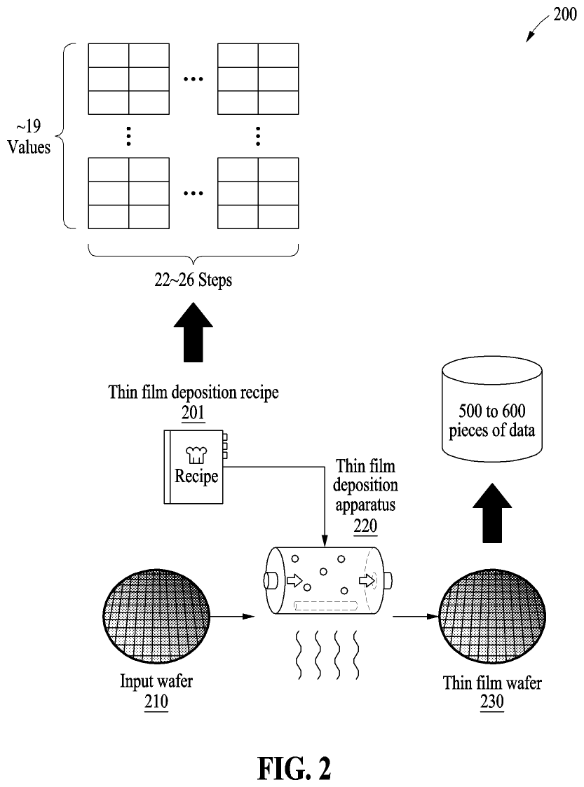

The target process may correspond to, for example, a thin film deposition, but is not necessarily limited thereto. The thin film deposition process is described with reference to FIG. 2.

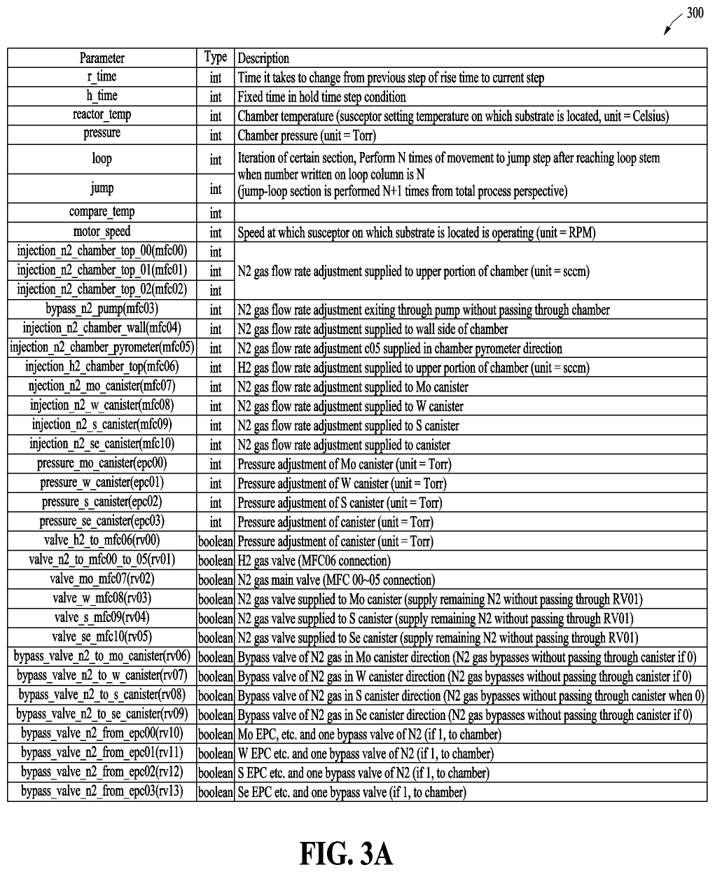

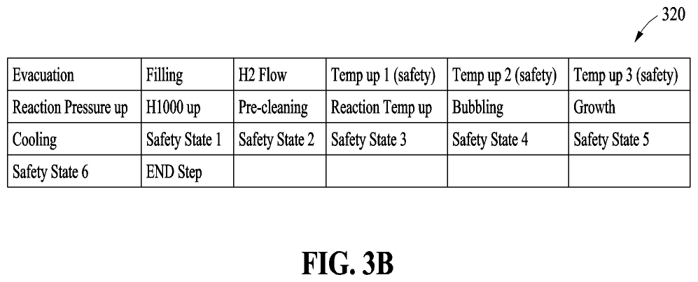

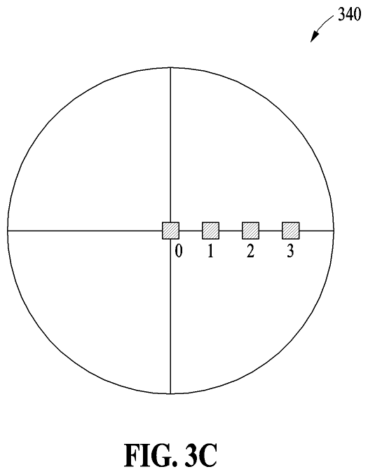

The pieces of recipe data may include at least one process variable (process condition). Examples of process conditions are a catalyst, a wafer size, and/or process parameters that are sequentially controlled during the target process. The process conditions may have a predetermined search interval and may include detailed conditions (e.g., four or more) having two or more valid search intervals. An example of the pieces of recipe data is described with reference to FIGS. 3A and 3B.

The pre-trained process result predictor may be implemented as, for example, a neural network trained to predict a process recipe for material synthesis corresponding to the target physical properties. The process recipe may include both a process/procedure and the pieces of recipe data including at least one of the process conditions/parameters mentioned above.

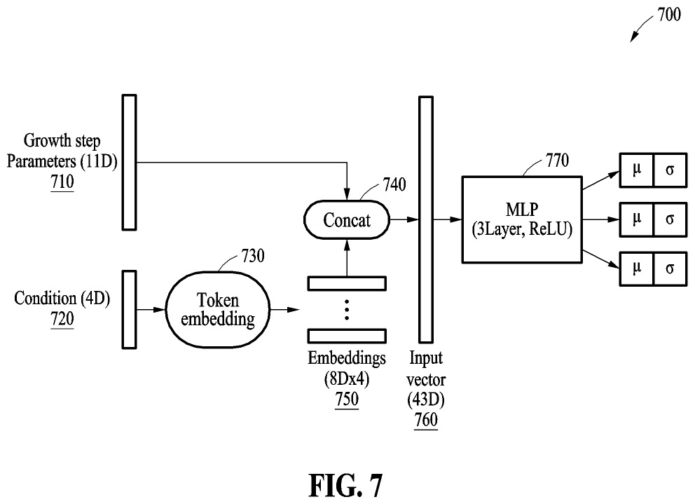

The pre-trained process result predictor may be trained through preprocessed pieces of recipe data by filtering, from among the above-mentioned pieces of recipe data, a piece of recipe data having a valid physical property numerical value or a piece of preprocessed recipe data in an unstandardized form. Here, the preprocessing may involve quantifying the pieces of recipe data (which may be in a vector form) by tokenizing the pieces of recipe data into identifiers for each process condition. A method of quantifying the pieces of recipe data in a vector form by tokenizing the pieces of recipe data is described with reference to FIG. 7.

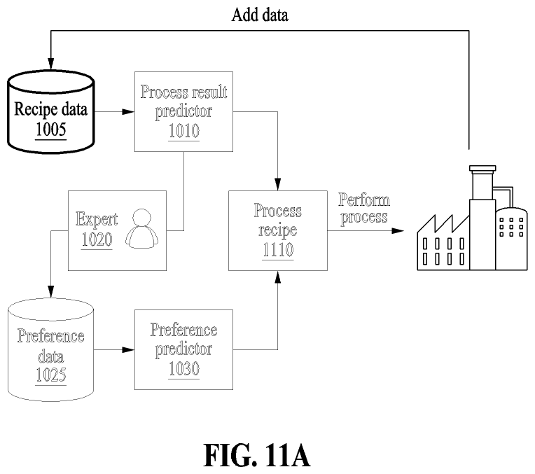

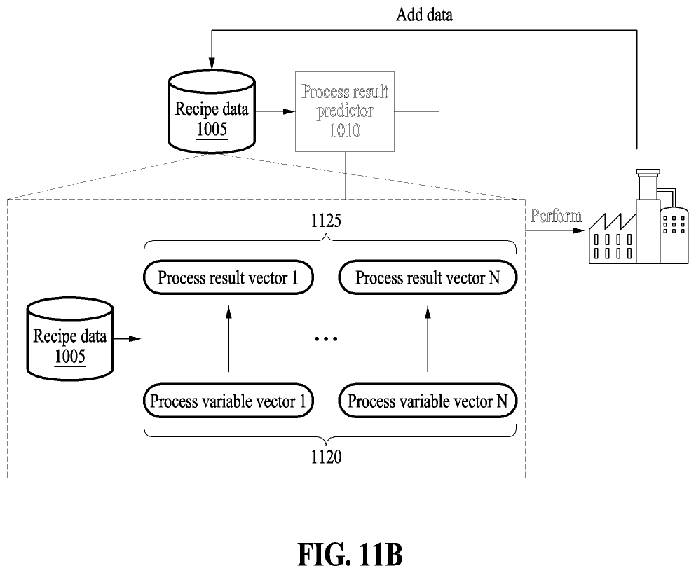

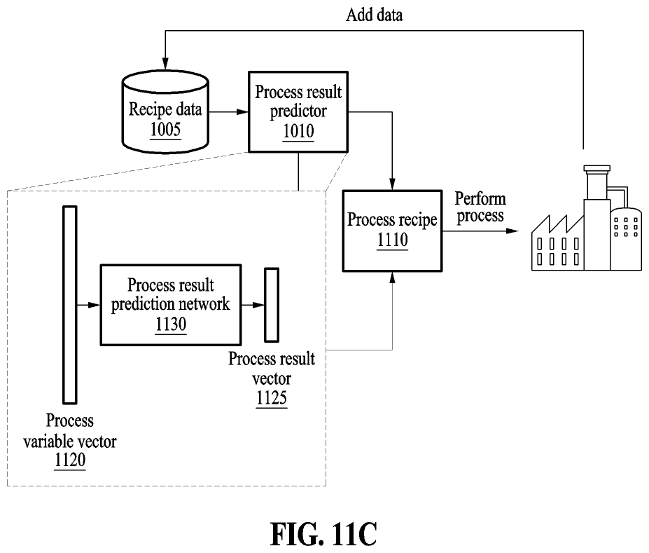

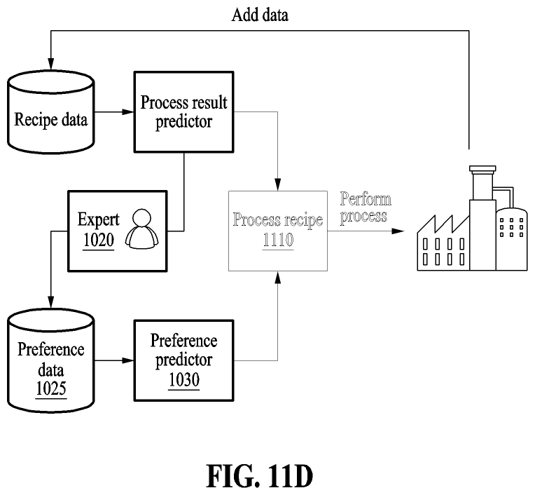

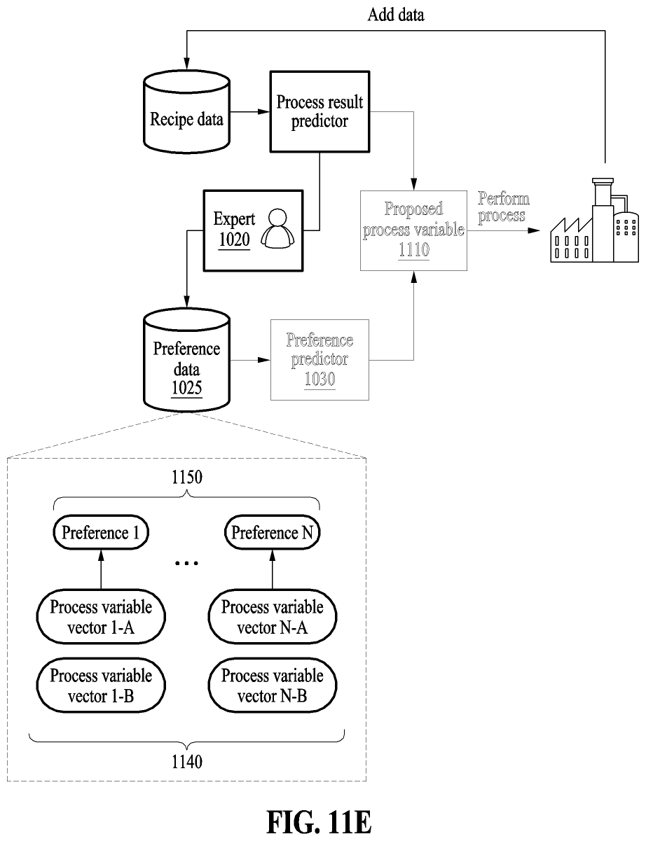

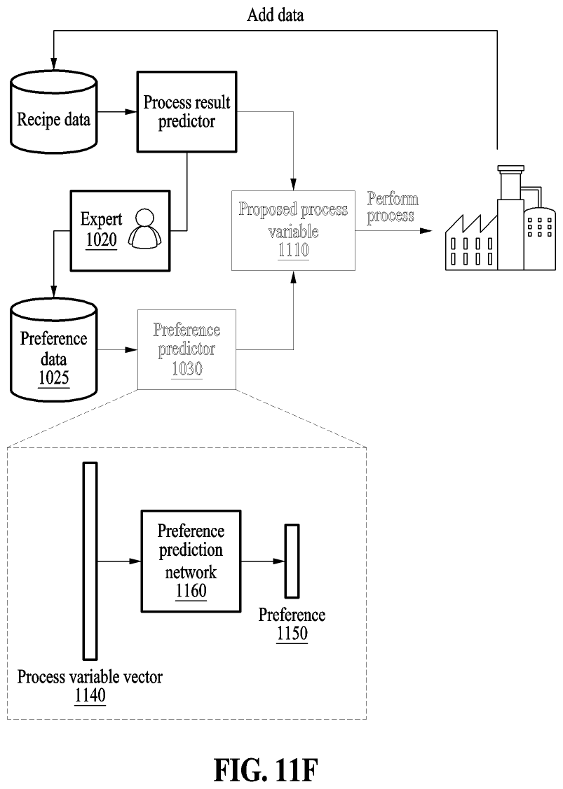

The process result predictor may be/include a trained neural network (e.g., a process result prediction network of FIG. 11C) that has been trained to predict the target physical properties corresponding to the candidate process recipes, based on the pieces of recipe data. The process result prediction network may also be referred to as a ‘physical property prediction model’ in that the process result prediction network may also predict physical properties of a material generated according to the process result. Hereinafter, the process result predictor and the physical property prediction model may be understood to have the same meaning.

The candidate process recipes may correspond to a candidate group of the target process recipe. The candidate process recipes may each include a respective combination of process variables (e.g., the process conditions and the process parameters) and/or process procedures for the material synthesis corresponding to the target physical properties but are not necessarily limited thereto.

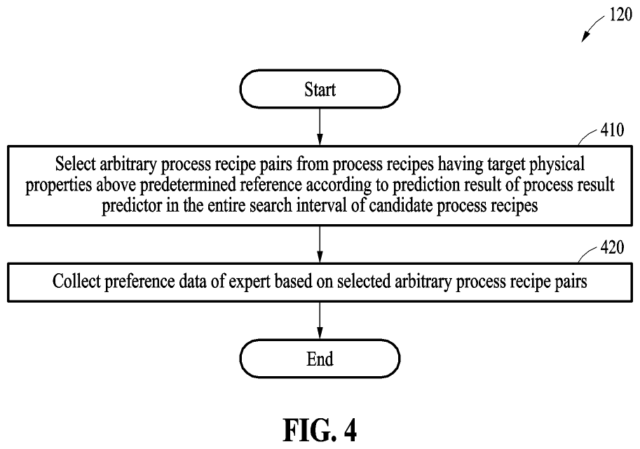

In operation 120, the recommendation apparatus may collect preference data of an expert for arbitrary process recipe pairs selected from among the candidate process recipes selected from operation 110. Here, the ‘expert’ may correspond to a process expert who has a good understanding of physical features of a process. A method in which the recommendation apparatus collects the preference data is described with reference to FIG. 4.

In operation 130, the recommendation apparatus may train a preference predictor to predict the preference of the expert for the arbitrary process recipe pairs, using the preference data collected from operation 120. The preference predictor may be trained based on the preference data of the expert for the process recipe and may predict the preference of the expert for the arbitrary process recipe pairs. The preference predictor may include a trained neural network (e.g., a preference prediction network of FIG. 11F) to predict the preference of the expert for the arbitrary process recipe pairs, based on the preference data of the expert. The preference prediction network may also be referred to as a ‘preference prediction model’ in that the preference prediction network predicts a process recipe preferred by the process expert.

For example, the recommendation apparatus may initialize the preference predictor using the physical property prediction model of the process result predictor. The recommendation apparatus may train the last linear layer of the preference predictor to predict the preference of the expert.

In operation 140, the recommendation apparatus may recommend, among the candidate process recipes selected from operation 110, the target process recipe for the target process, based on the target physical properties predicted by the process result predictor and a preference prediction value predicted by the preference predictor trained in operation 130 in response to the candidate process recipes.

The recommendation apparatus may specify a search interval of the process recipe by considering valid intervals of the target physical properties and the process parameters. The recommendation apparatus may exclude a constraint area corresponding to a predetermined condition in the entire search interval of the candidate process recipes, based on data distribution and a normalization range of the process parameters corresponding to the search interval of the process recipe. The recommendation apparatus may determine the target process recipe in the entire search interval based on the remaining search intervals other than the constraint area. The ‘search interval’ of the process recipe may, for example, correspond to an interval of a physical property numerical value of a material generated according to the process recipe or to an interval of the data distribution of the process parameters but is not necessarily limited thereto.

For example, the recommendation apparatus may determine the target process recipe based on a score function that indicates a degree to which the target physical properties match physical properties predicted for each label by the pre-trained process result predictor. Using the score function, the recommendation apparatus may convert a degree to which each of physical property numerical values predicted by the pre-trained process result predictor in response to the candidate process recipes is close to a numerical value of the target physical properties into quality scores. The recommendation apparatus may convert a degree to which each of the physical property numerical values predicted by the process result predictor is close to the numerical value of the target physical properties into scores between [0, 1], for example. The recommendation apparatus may determine the target process recipe based on the converted quality scores. For example, the recommendation apparatus may determine a process recipe corresponding to the highest quality score among the converted quality scores to be the target process recipe.

In addition, the recommendation apparatus may, for example, adjust a reflection ratio between the target physical properties and the preference prediction value. The recommendation apparatus may recommend, among the candidate process recipes, the target process recipe for the target process according to the adjusted reflection ratio.

Through active learning, manpower efficiency may be improved by automating a process in which the expert identifies the pieces of recipe data and reflects the pieces of recipe data in a search, and detailed numerical optimization may be expected. In addition, a framework that trains a machine learning model to perform property prediction and/or process prediction and selects a target process recipe to be efficiently tested using the quality of predicted physical properties may be developed.

FIG. 2 illustrates an example of a procedure of a thin film deposition process, according to one or more embodiments. FIG. 2 shows a diagram 200 of a thin film deposition process based on a thin fil deposition recipe 201. The thin film deposition process is just one example of a process procedure (i.e., a physical-process procedure).

The thin film deposition process is often used in semiconductor or quantum processor (qubits) manufacturing processes and may involve, for example, forming a fine thin film that controls the flow of electricity in an electronic device such as a semiconductor chip. The thin film deposition process may involve depositing/growing a fine film of a suitable material onto a substrate (e.g., an input wafer 210). Hereinafter, for ease of description, a case in which a process recipe is a thin film deposition recipe 201 is described as an example, but examples are not necessarily limited thereto. The method of recommending a process recipe may be applied to various other industrial processes.

According to the thin film deposition recipe 201, a thin film deposition apparatus 220 may form thin films of various materials onto the input wafer 210. The thin film deposition apparatus 220 may form a thin film by, for example, physical vapor deposition (PVD), chemical vapor deposition (CVP), atomic layer deposition (ALD), etc., to name some non-limiting examples. PVD involves depositing deposition agents in the form of gas or liquid and may form a thin film by mainly ionizing the deposition agents and causing the deposition agents to collide with an electrode. PVD may be performed in a vacuum state and may generate a thin film through a collision between deposition agents and an object. PVD may be referred to as ‘physical deposition’ because PVD directly vaporizes and deposits deposition agents in a vacuum state. CVD may involve depositing a thin film by chemical reaction between a gaseous reactive precursor and an element or a chemical material. CVD may mainly generate a thin film of silicon, nitride, and/or metal oxide by using various chemical reactions. CVD may controlled to easily adjust a desired deposition speed, thickness, and/or a structure of the formed thin film. ALD may involve forming a thin film through the reaction of one atomic layer at a time. The ALD may form a thin film by reacting each atomic layer and then injecting the atomic layer reacted in a reactor one atomic layer at a time. This process may be precisely controlled and may be suitable for controlling the thickness at the nanometer level, for example. Additionally, ALD may be used to improve a feature of a semiconductor chip by precisely forming oxides, nitrides, etc.

Since a process experiment performed according to a one-time process recipe (e.g., the thin film deposition recipe 201) might takes tens of hours and can incur significant manpower costs to be performed, a recommendation apparatus may be used to perform a search of process procedures with high search efficiency. Note that a process recipe may include various process procedures for certain purposes such as, for example, removing foreign materials, supplying reactants, reaction, and/or cooling, etc. Various parameters of a process procedure may be adjusted according to the purpose thereof.

The thin film deposition recipe 201 may include many process procedures (e.g., 22 to 26) and each process procedure may have many adjustable process parameters (e.g., 19 or 37). The process parameters of a process procedure (i.e., process step) may have a valid search interval (an interval/range of values within which the parameters are valid) depending, for example, on limitations of a corresponding apparatus (e.g., the thin film deposition apparatus 220) and/or experimental constraints, etc. The recommendation apparatus may receive a valid search interval and may use the valid search interval in preprocessing pieces of recipe data (a processing process).

Experiment-based data for meaningful searching for process parameters may be obtained by actually performing the thin film deposition process shown in FIG. 2; such experimental-based data may include, for example, 500 to 600 pieces of data. Such searchable experiment-based data may also be referred to as ‘recipe data’ (data obtained from performing the recipe). The recipe data may be stored in a database for further use, as described. Compared to ranges of potential adjustability of all respectively corresponding process parameters, a database, as previously used, may include pieces of data for an extremely small portions of the adjustability ranges of process parameters. In actual existing/previous parameter searching processes, an efficient parameter search may be improved when information such as domain knowledge or preferences of a human with expertise related to the process recipe (information which that is not in the database) is also considered. Even when augmented with human-expert information, a parameter search may be inadequate.

The recommendation apparatus may, based on deep learning, find and recommend (e.g., by inference) an optimal target process recipe (including values of process parameters) from which targeted physical properties (‘target physical properties’) may be provided. For example, a target physical property may be even synthesis and/or deposition by the thin film deposition apparatus 220.

FIG. 3A illustrates an example of standard of pieces of recipe data. Table 300 illustrates the standard of the pieces of recipe data, which are based on result data obtained by measuring performance of a process recipe (for a thin film deposition process) and physical properties after the performance. The table 300 is shown in schematic form, but in practice the table may include actual values of the pieces of recipe data (i.e., values of the process parameters).

For example, one process recipe may include several process steps having respective purposes such as preparation, cooling, reaction, etc. Each process step may include one or more corresponding process parameters (among the 37 process parameters shown in the table 300) for controlling a deposition apparatus. In addition, the step of the process procedure may vary from at least 22 to 25 steps according to the type of recipe, and the process order and composition according to the recipe may also vary according to the intention of an experiment.

FIG. 3B illustrates an example of the main steps of a process procedure according to the type of process. Table 320 illustrates the main steps of the process procedure.

Raw data (measures of the physical properties for each process recipe) and a qualitative value calculated from the raw data may be included in the pieces of recipe data, but the following three physical property numerical values (e.g., e_a_ratios, e2g_fwhm, and dc_e_ratios) that may represent a process condition of the target physical properties may be used. Here, the physical property numerical values may correspond to physical properties generated by primarily processing the raw result measured by the Raman spectrum.

e_a_ratios may be a ratio E_2g/A_1g between E_2g and A_1g peak and may correspond to a physical property numerical value associated with the grain size and coverage of a two-dimensional (2D) semiconductor material. e2g_fwhm may be a full width at the half maximum of E_2g peak and may correspond to a physical property numerical value associated with the crystallinity and coverage of a 2D semiconductor material. dc_e_ratios may be a ratio D_c/E_2g between D_c peak and E_2g peak and may correspond to a physical property numerical value associated with a defect ratio of a 2D semiconductor material.

FIG. 3C illustrates an example of a search interval, according to one or more embodiments. Diagram 340 illustrates a condition search interval for a testable process. Diagram 340 is a thin film wafer resulting from performing the process recipe.

Regarding the previously mentioned pieces of recipe data used by a recommendation apparatus, physical properties of the result (e.g., thin film wafer) of performing the process recipe may be measured at various locations, as shown in the diagram 340. There may also be several search intervals of the physical property numerical values (e.g., e_a_ratios, e2g_fwhm, and dc_e_ratios) that represent the process conditions of the target physical properties for each recipe. The recommendation apparatus may use, as the pieces of recipe data, a total of 12 values measured at the four locations, e.g., 3 physical property numerical values measured at each of the 4 locations indicated by square points in the diagram 340.

FIG. 4 illustrates an example of a method of collecting preference data, according to one or more embodiments. Referring to FIG. 4, a recommendation apparatus may collect preference data of an expert through operations 410 and 420.

In operation 410, the recommendation apparatus may select arbitrary process recipe pairs from among process recipes having target physical properties above a predetermined reference according to the prediction result of a process result predictor in the entire search interval of candidate process recipes. The recommendation apparatus may filter, for example, candidate process recipes predicted to have a score that is higher than a predetermined reference in the entire search range corresponding to the target physical properties predicted by the process result predictor. The recommendation apparatus may select the arbitrary process recipe pairs by sampling the selected arbitrary process recipe pairs from among the filtered candidate process recipes.

In operation 420, the recommendation apparatus may collect the preference data of the expert based on the selected arbitrary process recipe pairs from operation 410. The recommendation apparatus may collect, among the selected arbitrary process recipe pairs from operation 410, any one process recipe selected by the expert as the preference data.

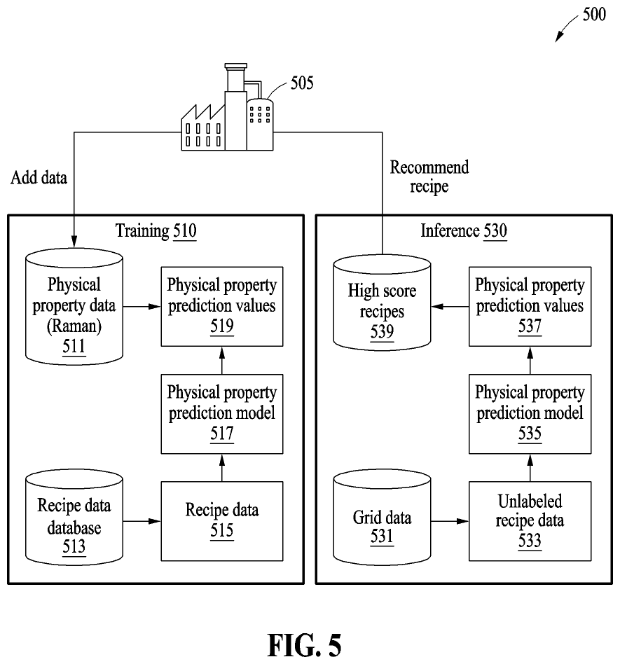

FIG. 5 illustrates an example of a deep learning-based thin film deposition process optimization system. Diagram 500 illustrates a training process 510 and an inference process 530 for a process optimization system 505 including a recommendation apparatus based on deep learning.

In the training process 510, the recommendation apparatus may (i) train a physical property prediction model 517 with recipe data 515 included in a recipe data database 513 and may (ii) calculate physical property prediction values 519 through physical property data (Raman) 511 provided from the trained physical property prediction model 517 and the process optimization system 505. Here, the physical property data (Raman) 511 may correspond to, for example, Raman spectrum measurement data indicating the degree to which Raman scattering is shifted on the spectrum but is not necessarily limited thereto.

In the inference process 530, the recommendation apparatus may calculate physical property prediction values 537 by inputting unlabeled recipe data 533 stored in a database (e.g., grid data 531), which stores grid data, to a physical property prediction model 535 pre-trained through the training process 510.

The recommendation apparatus may select target process recipes (e.g., high score recipes 539) with the maximum quality score through a grid search in a search interval defined based on the physical property prediction values 537 and may recommend the target process recipes (e.g., the high score recipes 539) to the process optimization system 505 as an overall target process recipe.

The recommendation apparatus may update the recipe data 515 after an experiment is performed according to the target process recipes (e.g., the high score recipes 539) of which the quality is expected to be the best in the entire search interval corresponding to the calculated physical property prediction values 537. The recommendation apparatus may, using the updated recipe data 515, the physical property prediction model 517, which is additionally trained in the training process 510, may recommend a better-quality process recipe. The recommendation apparatus may recommend the target process recipes (e.g., the high score recipes 539) corresponding to a physical property prediction value with the highest score (among the physical property predicted values 537) to the process optimization system 505.

As described above, the training process 510 and the inference process 530 may be repeatedly performed on the recommendation apparatus so that prediction performance may be improved.

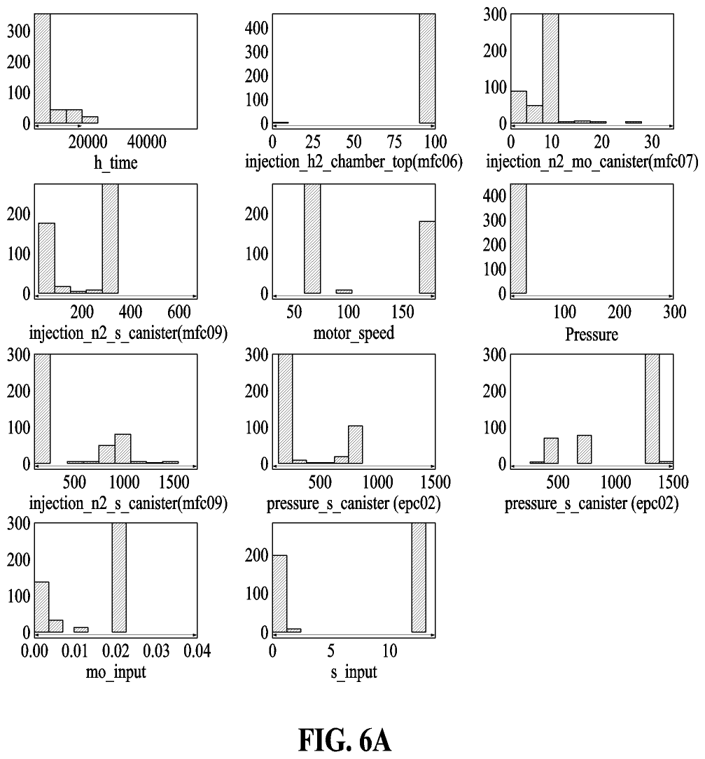

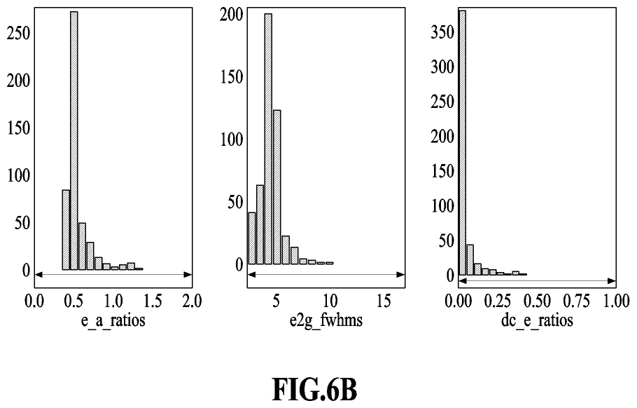

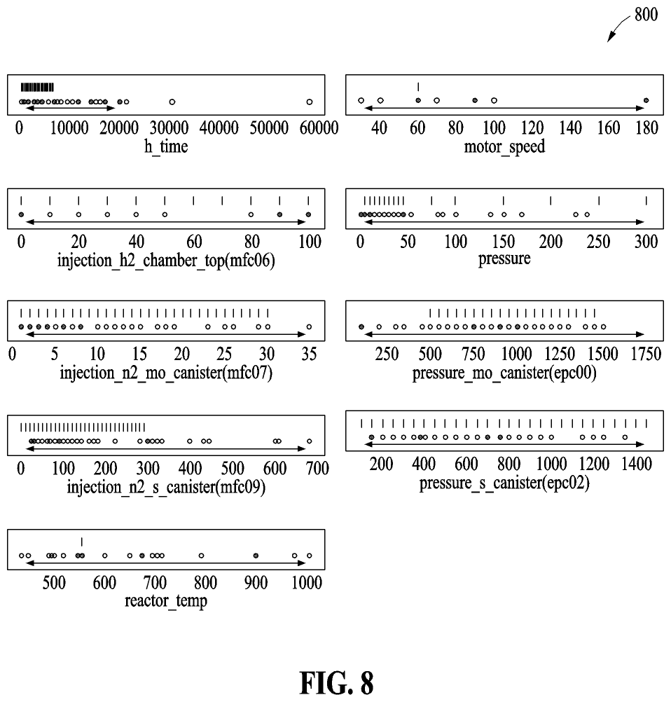

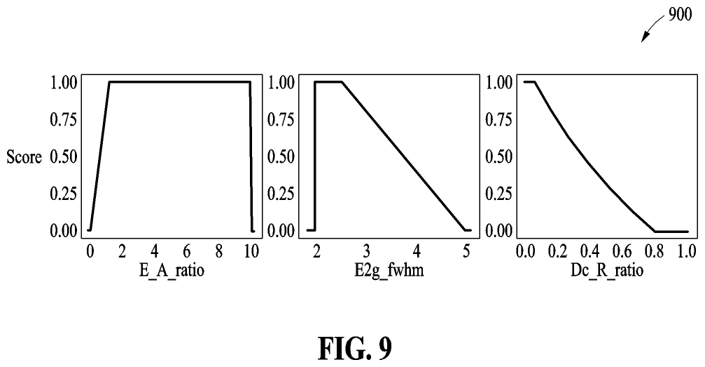

A processing process of the recipe data 515 to train the physical property prediction model 517 is described with reference to FIGS. 6A and 6B. In addition, the training process 510 of the physical property prediction model 517 is described with reference to FIG. 7, and a process of selecting a target process recipe to be tested through the physical property prediction model 535 is described with reference to FIGS. 8 and 9.

FIGS. 6A and 6B illustrate examples of a processing process of pieces of recipe data to train a process result predictor, according to one or more embodiments. FIG. 6A shows graphs illustrating distribution of nine process parameters (e.g., h_time, reactor_temp, pressure, motor speed, injection_h2_chamber_top(mfc06), injection_n2_mo_canister(mfc07), injection_n2_s_canister(mfc09), pressure_mo_canister(epc00), and pressure_s_canister(epc02)) used in a process of growing a thin film and two added physical property numerical values (e.g., mo_input and s_input). In addition, FIG. 6B shows graphs illustrating a result of normalizing three physical property numerical values (e.g., e_a_ratios, e2g_fwhms, and dc_e_ratios) that represent a process condition of target physical properties.

A recommendation apparatus may receive a process recipe including each piece of recipe data and may quantify and/or normalize the process recipe and physical properties in a vector form to train a physical property prediction model through supervised learning.

The recommendation apparatus may use, for example, 479 pieces of data obtained by filtering out 36 pieces of data out of 515 pieces of data for training. Here, the pieces of recipe data that are input to the physical property prediction model may include, for example, basic process conditions for a process, such as a catalyst, a wafer size, etc., and process parameters that are sequentially controlled during the process according to a target process recipe. The process conditions may have a certain category, or value(s) having a predetermined search interval. The process conditions may include, as features, detailed conditions (e.g., 4) having two or more valid categories.

The recommendation apparatus may use the process conditions as input vectors by tokenizing the process conditions into, for example, identifications (IDs) shown in Table 1 below.

TABLE 1

| Substrate | none | SiO | AlO | HfO |
|---|---|---|---|---|
| Token | 0 | 1 | 2 | 3 |

| Catalyst | none | N/RE | KI/RE | KI/SC | X | NPP | NaOtBu | KI/EV |
|---|---|---|---|---|---|---|---|---|
| Token | 0 | 1 | 2 | 3 | 4 | 5 | 6 | 7 |

| Pretreatment | none | O2P | X | O2A |
|---|---|---|---|---|
| Token | 0 | 1 | 2 | 3 |

| Wafer Size | 8 | 6 | none |
|---|---|---|---|
| Token | 0 | 1 | 2 |

Here, the ‘tokenizing’ refers to translating a word/field to a corresponding number, i.e., token. Since numbers are preferable for machine learning, the recommendation apparatus may use labels corresponding to the process conditions as input vectors by substituting the labels with certain numbers corresponding to certain tokens. For example, there are four cases in the items of substrate, none, SiO, AlO, and HfO, which may be used for training by corresponding to the numbers 0, 1, 2, and 3, respectively.

For example, the wafer sizes 8, 6, and none may be mapped to tokens of 0, 1, and 2, respectively.

Although more than 20 pieces of sequential recipe data may be actually used in the process procedure, the recommendation apparatus may use the process parameters in a growth process of a thin film, which is a main process controlling a material synthesis environment. This may be based on a process feature that most of the remaining process procedures are actually adjusted to correctly create an intended synthetic environment in the growth process of the thin film.

The recommendation apparatus may use 9 process parameters listed in Table 2 below as inputs of the physical property prediction model 517 by reflecting, among the process parameters, a target process feature in the growth process of the thin film.

TABLE 2

| Feature | Meaning |
|---|---|
| h_time | Hold time. Fixed time in a current step |
| | condition |
| reactor_temp | Chamber temperature (i.e., susceptor |
| | setting temperature in which a substrate is |
| | located, unit = Celsius) |
| pressure | Chamber pressure (unit = Torr) |
| motor_speed | Speed at which a susceptor on which a |
| | substrate is located is operating (unit = |
| | revolutions per minute (RPM)) |
| injection_h2_chamber_top(mfc06) | H2 gas flow rate adjustment that is supplied |
| | to the upper portion of a chamber (unit = |
| | standard cubic centimeter per minute |
| | (sccm)) |
| injection_n2_mo_canister(mfc07) | N2 gas flow rate adjustment that is supplied |
| | to Mo canister |
| injection_n2_s_canister(mfc09) | N2 gas flow rate adjustment that is supplied |
| | to S canister |
| pressure_mo_canister(epc00) | Pressure adjustment of Mo canister (unit = |
| | Torr) |
| pressure_s_canister(epc02) | Pressure adjustment of S canister (unit = |
| | Torr) |

The recommendation apparatus may additionally calculate the injection amount of materials used in the reaction according to Table 3 below and may allow the physical property prediction model 517 to use the calculation result.

TABLE 3

| Feature | Derivation |
|---|---|
| Mo Input | (0.2435/“pressure_mo_canister(epc00)” * |
| | “injection_n2_mo_canister(mfc07)”/ |
| | (1 − (0.2435/“pressure_mo_canister(epc00)”)) |
| S Input | (5.7086/“pressure_s_canister(epc02)”) * |
| | “injection_n2_s_canister(mfc09)”/ |
| | (1 − (5.7086/“pressure_s_canister(epc02)”)) |

For example, FIG. 6A shows the distribution of the 9 process parameters (e.g., h_time, reactor_temp, pressure, motor speed, injection_h2_chamber_top(mfc06), injection_n2_mo_canister(mfc07), injection_n2_s_canister(mfc09), pressure_mo_canister(epc00), and pressure_s_canister(epc02)) used in the growth process of the thin film and the two added physical property numerical values (e.g., mo_input and s_input) as shown in Table 3.

The recommendation apparatus may use these 11 features as input vectors for the physical property prediction model 517.

To effectively process different numerical ranges for each feature, the recommendation apparatus may convert determinations of whether the respective physical property numerical values predicted by the physical property prediction model 517 are close to a numerical value of the target physical properties into scores between [0, 1]. The recommendation apparatus may use these normalized values using the ranges in Table 4 below so that each of the physical property numerical values predicted by the property prediction model 517 does not deviate from, for example, the [0, 1] range.

TABLE 4

| Feature | Normalize a | Normalize b |
|---|---|---|
| h_time | 600 | 20000 |
| injection_h2_chamber_top(mfc06) | 0 | 100 |
| injection_n2_mo_canister(mfc07) | 1 | 35 |
| injection_n2_s_canister(mfc09) | 1 | 681 |
| motor_speed | 30 | 180 |
| pressure | 1 | 300 |
| pressure_mo_canister(epc00) | 100 | 1750 |
| pressure_s_canister(epc02) | 100 | 1500 |
| reactor_temp | 435 | 1000 |
| mo_input | 0 | 0.04 |
| s_input | 0 | 14 |

The recommendation apparatus may normalize the 11 features, for example, through the formula

$$\tilde{x} = CLIP [ \frac{x - a}{b - a} , 0 , 1 ] .$$

The formula

$$\tilde{x} = CLIP [ \frac{x - a}{b - a} , 0 , 1 ]$$

map X between 0 and 1 and may also be referred to as a min-max scaling function. x denotes an actual value, b denotes the maximum that the x may have, and a denotes the minimum. When a value exceeds the maximum or is less than the minimum, which is previously investigated in the test case, a value that is greater than or equal to 1 may be clipped to 1, and a value that is less than or equal to 0 may be clipped to 0. In sum, x_tilde only has a value between 0 and 1.

In addition, the recommendation apparatus may predict the following three physical property numerical values (e.g., e_a_ratios, e2g_fwhms, and dc_e_ratios) based on an input of the physical property prediction model 517, as shown in Table 4. Here, the predicted physical property numerical values may include pieces of recipe data measured at four locations for each numerical value, as shown in FIG. 6B. FIG. 6B may show the distribution of values obtained by averaging four numerical values measured at each location.

As processed in the process procedure, the recommendation apparatus may obtain normalized values using the ranges in Table 5 below so that each of the physical property numerical values predicted by the physical property prediction model 517 does not deviate from the [0, 1] range.

TABLE 5

| Feature | Search Min | Search Max | Search Interval |
|---|---|---|---|
| h_time | 600 | 6900 | 300 |
| injection_h2_chamber_top(mfc06) | 0 | 100 | 10 |
| injection_n2_mo_canister(mfc07) | 1 | 30 | 1 |
| injection_n2_s_canister(mfc09) | 1 | 291 | 10 |
| motor_speed | 60 | 60 | fixed |
| pressure | 5 | 300 | 5~50: 5 |
| | | | 50~100: 25 |
| | | | 100~300: 50 |
| pressure_mo_canister(epc00) | 100 | 1500 | 50 |
| pressure_s_canister(epc02) | 100 | 1500 | 50 |
| reactor_temp | 555 | 555 | fixed |

The recommendation apparatus may normalize the above three physical property numerical values that represent the process conditions of the target physical properties through, for example, the formula

$$\tilde{y} = CLIP [ \frac{y - a}{b - a} , 0 , 1 ] .$$

The formula

$$\tilde{y} = CLIP [ \frac{y - a}{b - a} , 0 , 1 ] ,$$

another normalization formula, maps y between 0 and 1 and may be referred to as a min-max scaling function.

FIG. 7 illustrates an example of a training method of a process result predictor. Diagram 700 illustrates the training process of a process result predictor based on the non-limiting example of 11 process parameters used in a growth process of a thin film and 4 process conditions.

A recommendation apparatus may train the process result predictor to predict arbitrary physical properties by applying training data (processed through the procedure described above) to the process result predictor having a deep neural network structure shown in FIG. 7.

The recommendation apparatus may train, through supervised learning, the process result predictor to predict a physical property numerical label using pieces of recipe data preprocessed through the procedure described above as an input.

To predict physical property numerical values measured at various locations for each process recipe, the recommendation apparatus may train the process result predictor to predict a search interval expected for each physical property numerical value using normal distribution. This may be a simplified method in which the process result predictor predicts only the size of the variation because it is expected that there are difficulties in accurately predicting a difference according to a location having a less amount of data.

For example, when recipe data D is given as

$$D = {\{ {\{ {x}_{i}^{( l )} , {\{ {y}_{i , p}^{( l )} \}}_{p = 1 …4} \}}_{l = 1 …3} \}}_{i = 1 … N} ,$$

the recommendation apparatus may train the process result predictor to predict a physical property label using loss L as shown in Equation 1 below. Here, x denotes an input and y denotes an output (physical properties). However, in the case of output, y may have p (e.g., 1 to 4) values rather than one value. For example, in the case of Raman, four measurements may be performed per sample, so there may be multiple outputs.

The recommendation apparatus may process N samples and may predict l physical properties per sample. Here, i denotes the index of a corresponding sample.

$$L = - \frac{1}{N} {\sum }_{i = 1}^{N} {\sum }_{l = 1}^{3} {\sum }_{p = 1}^{4} log N ( {y}_{i , p}^{( l )} \vert {μ}^{( l )} ( {x}_{i} ) , {σ}^{( l )} ( {x}_{i} ) ) \qquad Equation 1$$

Here, the loss L is maximum likelihood loss for output normal distribution of the process result predictor.

Both μ^{l}(xᵢ) and σ^{l}(xᵢ) may correspond to an output of the process result predictor when an input

$${x}_{i}^{( l )}$$

is applied. The recommendation apparatus may assume that an output

$${y}_{i , p}^{l}$$

is a result value obtained from the normal distribution and may estimate the form of the normal distribution. Here, the form of the normal distribution may be determined by μ^{l}(xᵢ) and σ^{l}(xᵢ). That is, the training of the process result predictor may refer to minimizing an output L (e.g., L=½ log(2πσ\hat{ }2)+((y−μ)\hat{ }2/2σ\hat{ }2)) and training the output L to be close to distribution of actual pieces of data.

In addition, when the variation of the pieces of recipe data is greater than a predetermined reference in a range in which the physical property label is not important, the recommendation apparatus may train the process result predictor using the corrected loss as shown in Equation 2 below so that the prediction accuracy of the important range does not decrease due to the concentration in reducing loss in a corresponding range.

$$L = - \frac{1}{N} {\sum }_{i = 1}^{N} {\sum }_{l = 1}^{3} {\sum }_{p = 1}^{4} {w}_{i} ( {y}_{i , p}^{( l )} ) \cdot log N ( {y}_{i , p}^{( l )} \vert {μ}^{( l )} ( {x}_{i} ) , {σ}^{( l )} ( {x}_{i} ) ) \qquad Equation 2$$

Here, wₗ(y) may be a·scoreₗ(y)+b (i.e., Wₗ(y)=a·scoreₗ(y)+b). scoreₗ(y) may correspond to a score function indicating a degree to which each label matches the target properties. The score function scoreₗ(y) may have a range of [0, 1], for example.

The recommendation apparatus may train the process result predictor as it is but may train the process result predictor using a score function for maximization in terms of the optimization. The recommendation apparatus may enable training of the process result predictor by transforming physical properties into scores using a score function.

The form of a score function may vary, but the score function may have a high value to achieve the goal of training the process result predictor. The recommendation apparatus may set a weight Wᵢ wᵢ to be higher when a physical property value predicted by the process result predictor is close to a predetermined value and may set the weight wᵢ to be lower as the predicted physical property value moves away from the predetermined value.

The weight wᵢ may be used to differently assign weights to each sample during training. In Equation 2, the higher the scoreₗ(Y), the higher the weight wᵢ, and the recommendation apparatus may more strongly train a sample with high scoreₗ(Y). This may be based on the intuition that a sample with a high score is more important.

The recommendation apparatus may set the range of wₗ(y) to [0.1, 1], for example, by setting a to 0.9 (i.e., a=0.9) and b to 0.1 (i.e., b=0.1).

Through a process of token embedding 730 of FIG. 7, the recommendation apparatus may transform the number (e.g., a condition (four dimensions (4D)) 720) described above with the token into a feature with a certain dimension (e.g., an embedding size), such as a token embedding vector (e.g., four 8D embedding vectors) 750. The token embedding vector 750 may generally include a single matrix. The form of the token embedding vector 750 may be, for example, num_tokens or embedding_size but is not necessarily limited thereto.

The recommendation apparatus may substitute the token with a one-hot-vector to query the token embedding vector 750. The one-hot-vector may be a vector of which only one value is ‘1’, and the rest are ‘0’. Here, the token must be a positive integer.

For example, when the total number of tokens is 3, token 0 may be [1, 0, 0], token 1 may be [0,1,0], and token 2 may be [0, 0, 1]. Since the token substituted with the one-hot-vector is in the form of (1, num_token), the recommendation apparatus may query an embedding vector at a corresponding token location by multiplying an embedding matrix by the token substituted with the one-hot vector, using matrix multiplication.

A process of a Concat 740 may correspond to a process of connecting two or more vectors or matrices, that is, concatenating two or more vectors or matrices. For example, matrices in the form of (n, m) and (n, o) may be concatenated into a matrix in the form of (n, m+o) through the process of the Concat 740.

In the process of the Concat 740, the recommendation apparatus may concatenate a recipe parameter (11D) of a growth step 710 with the token embedding vector (e.g., the four 8D embedding vectors) 750. The result of the Concat 740, in this example, is a total of 43D vectors, which may be applied as an input vector 760 to a multi-layer perceptron (MLP) 770.

The MLP 770 may be a neural network with layers of interconnected nodes (e.g., fully connected layers). The number of layers of the MLP 770 and the size of its hidden layers may be freely set, and the number of outputs of the last layer may be set depending on the purpose.

In the case of FIG. 7, since a mean p and standard deviation std σ must be output three each, the size (number) of the last output layers may be 6.

FIG. 8 illustrates an example of a method of specifying a search interval of a process recipe to be tested using a trained process result predictor, according to one or more embodiments. Diagram 800 illustrates values of process parameters corresponding to the search interval of the process recipe along with data distribution and a normalization range.

A recommendation apparatus may specify the search interval of the process recipe by considering a physical limitation of a target process and a range of valid process parameters to select a recipe to be actually tested using the trained process result predictor through the process described above. For example, the recommendation apparatus may determine the search interval of the process recipe as shown in Table 6 below.

TABLE 6

| Feature | Search Min | Search Max | Search Interval |
|---|---|---|---|
| h_time | 600 | 6900 | 300 |
| injection_h2_chamber_top(mfc06) | 0 | 100 | 10 |
| injection_n2_mo_canister(mfc07) | 1 | 30 | 1 |
| injection_n2_s_canister(mfc09) | 1 | 291 | 10 |
| motor_speed | 60 | 60 | fixed |
| pressure | 5 | 300 | 5~50:5 |
| | | | 50~100:25 |
| | | | 100~300:50 |
| pressure_mo_canister(epc00) | 100 | 1500 | 50 |
| pressure_s_canister(epc02) | 100 | 1500 | 50 |
| reactor_temp | 555 | 555 | fixed |

The recommendation apparatus may display the diagram 800 (e.g., as a user interface displayed by a display device) showing the data distribution and normalization range of the values of the process parameters corresponding to the search interval in Table 6. The recommendation apparatus may determine the search interval by adding constraints described below to exclude a constraint area (e.g., an invalid area) corresponding to a predetermined condition in the search interval in Table 6. For example, when a semiconductor material is grown by the process recipe and when the constraints are not satisfied, the semiconductor material may not grow at all, an error may occur in the equipment, or the equipment may malfunction. Here, the invalid area may correspond to an area on which an operation or growth according to the process recipe is not performed. The invalid area may be an area corresponding to a constraint to exclude the predetermined condition:

$$mo\_input < 0.005 ,$$

$$s\_input < 5 , and$$

$$100 < s\_input / mo\_input < 2000$$

The recommendation apparatus may find a process recipe that is predicted to be closest to target physical properties among process recipes within the previously determined search interval. To this end, the recommendation apparatus may calculate comprehensive scores using three physical property numerical values predicted by the process result predictor. The recommendation apparatus may be implemented to find a target process recipe that maximizes the comprehensive scores.

FIG. 9 illustrates an example of a method of calculating quality scores using physical property numerical values predicted by a process result predictor, according to one or more embodiments. Diagram 900 illustrates the method of calculating quality scores based on a score indicating the degree to which three physical property numerical values predicted by the process result predictor match numerical values of target physical properties.

A recommendation apparatus may convert the degree to which each of the physical property numerical values (predicted by the process result predictor) is close to a numerical value of desired target physical properties into scores between [0, 1]. The recommendation apparatus may calculate scores using a function (e.g., a score function) of the type shown in the diagram 900 for each physical property numerical value, using domain knowledge. The score function is a function that substitutes each of physical properties from 0 to 1, and score ‘1’ may indicate a good score, that is, a predicted physical property numerical value is similar to a numerical value of the desired target physical properties, and score ‘0’ may indicate a bad score, that is, a predicted physical property numerical value is not similar to a numerical value of the desired target physical properties.

The recommendation apparatus may transform, into a score, the degree to which the predicted physical property numerical value by the process result predictor using the score function is close to the numerical value of the desired target physical properties. Since the goal for each of the physical properties is different, and the scale for each of the physical properties is different, the recommendation apparatus may train the process result predictor so that the score for each physical property numerical value becomes ‘1’ while also unifying the scale.

The recommendation apparatus may calculate the quality scores corresponding to a comprehensive score as shown in Equation 3 below, using the score for each physical property numerical value.

$$Equation 3$$

$$Quality score = \frac{2 * e\_a \_ratio \_score + e 2 g\_fwhm \_score + dc\_e \_ratio \_score}{4}$$

The recommendation apparatus may find a process recipe that is predicted to be closest to the physical properties targeted for the process recipe (‘target physical properties’) within the previously determined search interval. The recommendation apparatus may calculate the quality scores using the three physical property numerical values predicted by the process result predictor and may find and recommend a target process recipe that maximizes the quality scores.

For example, a 10-fold validation mean value of a mean absolute error (MAE) of the trained process result predictor is shown in Table 7 below.

TABLE 7

| | E_a_ratios | E2g_fwhms | Dc_e_ratios | Quality Score |
|---|---|---|---|---|
| | score MAE | score MAE | score MAE | MAE |
| Deep Learning | 0.1181 | 0.1365 | 0.0183 | 0.1281 |
| (Gaussian | — | — | — | (0.1589) |
| Process) | | | | |

The recommendation apparatus may calculate the quality scores using the physical property numerical values predicted by the process result predictor using a mean value of output normal distribution for all four locations. The recommendation apparatus may recommend the process recipe with the highest quality score.

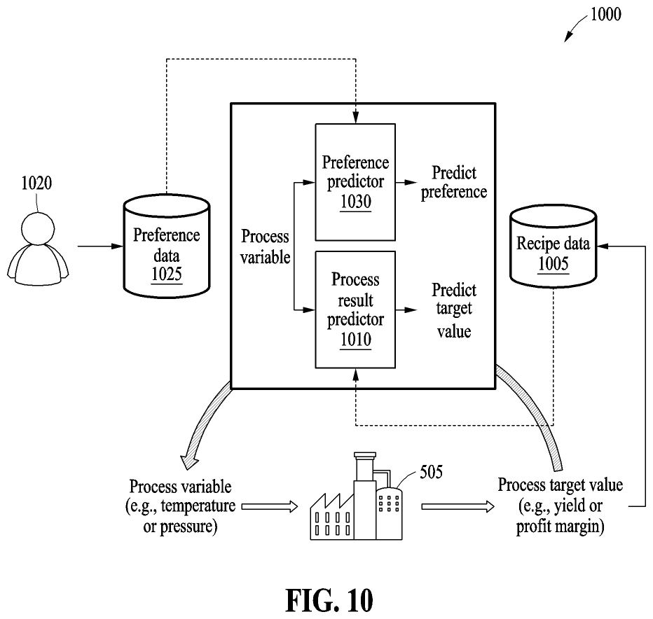

FIG. 10 illustrates an example of a deep learning-based thin film deposition process optimization system, according to one or more embodiments.

Referring to FIG. 10, a deep learning-based thin film deposition process optimization system 1000 (hereinafter, referred to as a “process optimization system”) may reduce the number of actual/physical process experiments required to be performed for optimization by proposing an efficient process recipe that is to be searched for through experiments during an optimization process.

To propose the efficient process recipe, the process optimization system 1000 may recommend an effective process recipe that may reduce costs by reflecting the preference of an expert 1020 having prior knowledge on a process in addition to the result of a process predicted based on the previous experimental result. As such a target process recipe recommended by the process optimization system 1000 shortens the number of experiments required for process optimization, the time and/or costs required for actual experiments may be linearly saved. In particular, the higher the cost of process experiments, the higher the efficiency may be expected in the optimization process.

The process optimization system 1000 may include a process result predictor 1010 and a preference predictor 1030. When preference data 1025 corresponding to a process recipe preferred by the expert 1020 and recipe data 1005 are input, the process optimization system 1000 may train the process result predictor 1010 based on the recipe data 1005 and may train the preference predictor 1030 based on the preference data 1025. The process optimization system 1000 may recommend an optimal process recipe that satisfies a process target value, such as yield or profit margin, using the trained process result predictor 1010 and the trained preference predictor 1030.

The process result predictor 1010 may be trained based on the recipe data 1005 and may predict a process result (e.g., target physical properties such as yield and profit margin) for an arbitrary process recipe. Here, the recipe data 1005 corresponds to actual process experimental data.

The preference predictor 1030 may be trained based on the preference data 1025 of the expert 1020 for the process recipe and may predict the preference of the expert 1020 for an arbitrary process recipe. Here, the preference data 1025 of the expert 1020 may be collected for a process recipe having target physical properties above a predetermined value according to a prediction result of the process result predictor 1010 in the search interval of valid process recipes. Additionally, the preference data 1025 of the expert 1020 may be collected, for example, in the form of selecting a process recipe that the expert 1020 relatively prefers among process recipe pairs.

The process result predictor 1010 and the preference predictor 1030 may derive an intended process result based on each piece of data (e.g., the recipe data 1005 and the preference data 1025) in the range of the valid process recipes and may appropriately select the process recipe(s) preferred by the process expert 1020 to search for first.

The preference predictor 1030 may utilize the prior knowledge of the expert 1020 using the preference of the expert 1020 for the process recipe to propose the process recipe. As described above, when the prior knowledge of the expert 1020 is used to determine (recommend) the process recipe, the optimization process may be shortened even when initial data for the process optimization process is insufficient. In addition, the preference predictor 1030 may provide only the preference of a search without the expert 1020 directly predicting the process result, so the process optimization efficiency may increase even in a complex process to which a method using a label of the expert 1020 may not be applied.

FIGS. 11A to 11F sequentially illustrate examples of a process optimization process by considering the preference of an expert, according to one or more embodiments.

Referring to FIG. 11A, a recommendation apparatus may accurately predict actual physical properties by training the process result predictor 1010 based on the recipe data 1005 for which an actual process experiment is performed, collect the preference data 1025 for the search interval preferred by the expert 1020 among the prediction results, and reflect the preference data 1025 when selecting a process recipe 1110. Here, the recipe data 1005 may, for example, correspond to a process result vector 1125 derived from process variable vectors 1120, as shown in FIG. 11B. The process variable vectors 1120 may be process parameters and process recipes and the variable vectors 1120 may correspond to value that are input to the equipment (e.g., the semiconductor process equipment). The process result vector 1125 may correspond to a result of performing a corresponding process. The process result vector 1125 may be, for example, physical properties or physical properties that pass the score function described above.

The process result predictor 1010 may predict, for example, the process result vector 1125 from the process variable vectors 1120 by a process result prediction network 1130, as shown in FIG. 11C.

The recommendation apparatus may analyze a recommendation trend of the process result predictor 1010 for each iteration, define a search space and a constraint of the process recipe 1110, and then reflect the search space and the constraint in a prediction process of the process recipe 1110. Here, a search interval excluded by the search space and the constraint may lose a search opportunity even when the prediction result of the process result predictor 1010 is significantly high. To solve this problem, after training the preference predictor 1030 that predicts the preference of the expert 1020 based on the preference data 1025 of the expert 1020 as shown in FIG. 11D, the process recipe 1110 searched for by considering a physical property prediction value corresponding to each process recipe and the preference of the expert 1020 in a balanced manner may be finally recommended.

Here, the preference data 1025 of the expert 1020 may be collected in the same method as shown in FIG. 11E. The recommendation apparatus may filter a process recipe predicted to have a high score in the entire search interval corresponding to the target physical properties predicted by the process result predictor 1010. The recommendation apparatus may filter candidate process recipes predicted to have a score that is higher than a predetermined reference in the entire search interval corresponding to the target physical properties predicted by the process result predictor 1010. The recommendation apparatus may sample arbitrary process recipe pairs among the filtered candidate process recipes and may allow the expert 1020 to label a process recipe that the expert 1020 wants to search for first. For example, the recommendation apparatus may allow the process expert 1020 to repeatedly label 100 arbitrary process recipe pairs among the previously selected 500,000 process recipes as a preference data 1025.

More specifically, the recommendation apparatus may sample a labeled arbitrary process recipe pair (e.g., a process variable vector 1140) among the filtered candidate process recipes. For example, the recommendation apparatus may select 500,000 samples that satisfy a constraint among approximately 18 million process recipes in the current search space as the preference 1150.

The recommendation apparatus may train the preference predictor 1030 to satisfy Equation 4 below through the preference data 1025 collected by the method described above.

$$D = {\{ ( {x}^{{a}_{i}} , {x}_{i}^{b} , {p}_{i} ) \}}_{i = 1 … N} \qquad Equation 4$$

Here, D denotes preference data of the expert 1020. x^{a} and x^{b} denote arbitrary process recipes, for example, sampled process recipe pairs. p may be obtained by a particular expert comparing process recipes x^{a} and x^{b} and labeling the process recipes x^{a} and x^{b} as −1 or 1 or 0.

For example, when the expert 1020 prefers x^{a}, p may be 1 (i.e., p=1), and when the expert 1020 prefers x^{b}, p may be −1 (i.e., p=−1). When the preference of the expert 1020 is uncertain, p may be 0 (i.e., p=0).

Here, loss L used for training the preference predictor 1030 may be expressed as Equation 5 below.

$$Equation 5$$

$$L = {\sum }_{i = 1}^{N} - log [ sigmoid ( p \cdot \{ f ( {X}_{i}^{a} ) - f ( {x}_{i}^{b} ) \} ) + ( 1 - \vert p \vert ) \cdot {\{ f ( {x}_{i}^{a} ) - f ( {x}_{i}^{b} ) \}}^{2}$$

Here, ƒ denotes a loss function used for training the preference predictor 1030 of the expert 1020. A process x may be applied to the loss function ƒ as an input. Here, when the process x is in the form preferred by experts, an output of the loss function ƒ may be higher than a predetermined reference, and when the process x is not in the form preferred by experts, the output of the loss function ƒ may be lower than the predetermined reference.

In Equation 5, when p is not 0, the preference of a preferred sample may be predicted higher than preference of a non-preferred sample (a first term). Additionally, when p is 0, the preference of the preferred sample may be predicted to be the same as the preference of the non-preferred sample (a second term).

For example, the recommendation apparatus may initialize a network of the preference predictor 1030 (e.g., a preference prediction network 1160) by a network of the pre-trained process result predictor 1010, as shown in FIG. 11F. Here, the preference prediction network 1160 may predict the preference 1150 from the process variable vector 1140 based on a value that is output by inputting the process x to the loss function ƒ described above. The preference 1150 may have, for example, a real number form. The preference 1150 may correspond to the preference of the expert 1020 for a process recipe including a process variable. The recommendation apparatus may increase sampling efficiency by training the last linear layer of the preference prediction network 1160 to predict a preference scalar value.

In addition, the recommendation apparatus may freeze a layer without performing token embedding performed when training the process result predictor described above with reference to FIG. 7 and updating a first linear layer to prevent catastrophic forgetting, in which an artificial neural network suddenly forgets previously trained information when training new information. Basically, in deep learning for an artificial neural network, an optimal weight may be found using gradient descent. However, the ‘freezing’ of the layer may refer to not reflecting the gradient for a parameter of an artificial neural network that has already been extensively trained.

The preference prediction network 1160 may share a portion of the pre-trained process result predictor 1010, and a portion (a portion of the process result predictor 1010) shared during the training process may also be updated. Accordingly, the information of the pre-trained process result predictor 1010 may be maintained by not freezing and updating a layer corresponding to the shared portion.

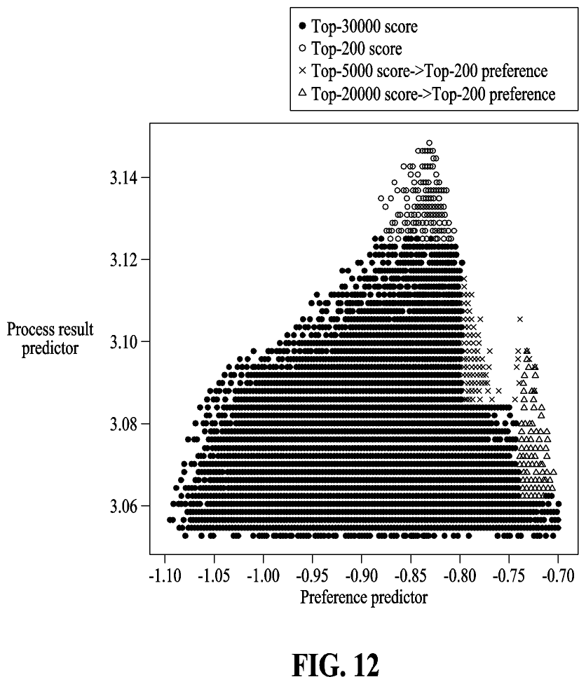

The recommendation apparatus may determine a process recipe to be finally tested by comprehensively using the prediction result of the preference predictor 1030 and the prediction result of the process result predictor 1010. The recommendation apparatus may visualize (e.g., in a user interface displayed on a display device) the degree of reflection of the preference 1150, for example, as shown in FIG. 12 below, and may adjust the degree of response to the preference 1150 through feedback from the expert 1020 provided to the user interface.

FIG. 12 illustrates an example of a method of recommending, among candidate process recipes, a target process recipe for a target process, based on target physical properties predicted by a process result predictor and a preference prediction value predicted by a preference predictor in response to the candidate process recipes, according to one or more embodiments.

The graph in FIG. 12 illustrates a graphical representation of a correlation between a quality score predicted by the process result predictor 1010 and the preference of an expert predicted by the preference predictor 1030. In the graph, the X-axis represents a preference score of the expert predicted for each process recipe and the Y-axis represents the predicted target physical properties.

All dots shown in the graph of FIG. 12 may correspond to process recipes, and a result of predicting a process result (e.g., the quality score) corresponding to the process recipe correspond to the score in the Y-axis.

In the graph, 30,000 process recipes having the highest target value (target physical properties) predicted by the process result predictor 1010 may be represented as circular black dots ●. The white dots ◯ may represent 200 process recipes having the highest predicted target value among the 30,000 process recipes.

Additionally, the x-shaped dots may represent 200 process recipes predicted to have the high preference of the expert after first filtering 5,000 process recipes having the highest target value predicted by the process result predictor 1010.

In addition, the triangle-shaped dots (show as Δ) represent 200 process recipes predicted to have the high preference of the expert among 20,000 process recipes after first filtering the 20,000 process recipes having the highest target process value predicted by the process result predictor 1010.

A recommendation apparatus may use the process recipes (e.g., the x-shaped dots and triangle Δ-shaped dots) that consider the preference of the expert, not just the process recipes (e.g., the circular black dots ●) having high target physical properties.

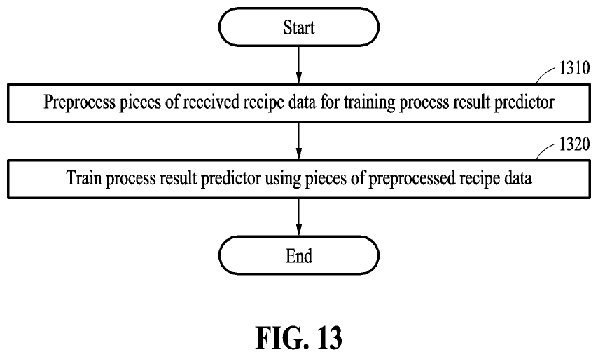

FIG. 13 illustrates an example of a training method of a process result predictor, according to one or more embodiments. Referring to FIG. 13, the process result predictor may determine a process for material synthesis corresponding to target physical properties through training in operations 1310 and 1320.

In operation 1310, the process result predictor may preprocess pieces of received recipe data for training the process result predictor. The process result predictor may filter, from among the pieces of recipe data, at least one of recipe data having a valid physical property numerical value or recipe data in an unstandardized form. The process result predictor may quantify and normalize a process corresponding to the pieces of recipe data and physical properties in a vector form. The process result predictor may receive each piece of recipe data and may perform a processing process to quantify and/or normalize, in a vector form, a process recipe and the physical properties on the pieces of recipe data for supervised learning of a model that predicts the physical properties. The process result predictor may quantify the pieces of recipe data in a vector form by tokenizing the pieces of recipe data into identifiers for each process condition.

In operation 1320, the process result predictor may be trained using the pieces of recipe data preprocessed in operation 1310. The process result predictor may be trained, among the pieces of recipe data preprocessed in operation 1310, by inputting process parameters used in a control process of a material synthesis environment. Here, the process result predictor may use a plurality of process parameters (e.g., 9) as inputs to the process result predictor by reflecting, among the process parameters, a process recipe corresponding to each step of process procedures, or a process feature aimed at searching.

The process result predictor may calculate the injection amount of materials additionally used in the reaction using the process parameters. The process result predictor may be trained by additionally inputting the injection amount of materials used in the reaction to the process result predictor. The process result predictor may be trained to predict a range expected for each physical property numerical value as normal distribution, for example, to predict physical property numerical values measured at multiple locations for each piece of preprocessed recipe data. The process result predictor may be trained through supervised learning to predict a physical property numerical label based on the pieces of preprocessed recipe data. The process result predictor may be trained using maximum likelihood loss for output normal distribution of the process result predictor.

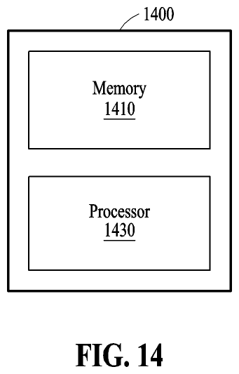

FIG. 14 illustrates an example of an apparatus for recommending a process recipe, according to one or more embodiments. An apparatus 1400 (hereinafter, also referred to as a recommendation apparatus) for recommending a process recipe may include a memory 1410 and one or more processors 1430. The one or more processors 1430 may select candidate process recipes for material synthesis corresponding to target physical properties based on a prediction result of a pre-trained process result predictor based on pieces of recipe data corresponding to a target process. The one or more processors 1430 may collect preference data of an expert for arbitrary process recipe pairs selected from among the candidate process recipes. The one or more processors 1430 may train a preference predictor to predict the preference of the expert for the arbitrary process recipe pairs, using the preference data. The one or more processors 1430 may recommend, among the candidate process recipes, a target process recipe for the target process, based on the target physical properties predicted by the process result predictor and a preference prediction value predicted by the preference predictor in response to the candidate process recipes.

Although mathematical notation is used above, it will be appreciated that the mathematical notation is an efficient language (compared to expository English) for describing the actions of the one or more processors 1430. The mathematical formulas and notation, along with the other descriptions above, may be readily expressed in the form of equivalent source code (or circuit/logic descriptor/specification language) which may be compiled into machine executable instructions that may be stored in memory and, when executed from the memory by the one or more processors 1430, cause the one or more processors 1430 to perform the operations described by the mathematical notation above (as well as other operations described above).

The examples described herein may be implemented using a hardware component, a software component (instructions), and/or a combination thereof. A processing device may be implemented using one or more general-purpose or special-purpose computers, such as, for example, a processor, a controller and an arithmetic logic unit (ALU), a DSP, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciate that a processing device may include multiple processing elements and/or multiple types of processing elements. For example, the processing device may include a plurality of processors, or a single processor and a single controller. In addition, different processing configurations are possible, such as parallel processors.

The software may include a computer program, a piece of code, an instruction, or some combination thereof, to independently or uniformly instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be those specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs and/or DVDs; magneto-optical media such as optical discs; and hardware devices that are specially configured to store and perform program instructions, such as read-only memory (ROM), random access memory (RAM), flash memory, and the like. Examples of program instructions include both machine code, such as produced by a compiler, and files containing higher-level code that may be executed by the computer using an interpreter.

The computing apparatuses, the electronic devices, the processors, the memories, the displays, the information output system and hardware, the storage devices, and other apparatuses, devices, units, modules, and components described herein with respect to FIGS. 1-14 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-14 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A method, performed by one or more processors, of recommending a process recipe, the method comprising:
selecting candidate process recipes for material synthesis corresponding to target physical properties based on a prediction result of a pre-trained process result predictor based on pieces of recipe data corresponding to a target process;
collecting preference data for arbitrary process recipe pairs selected from among the candidate process recipes;
training a preference predictor to predict preference for the arbitrary process recipe pairs, using the preference data; and
recommending, among the candidate process recipes, a target process recipe for the target process, based on the target physical properties predicted by the pre-trained process result predictor and based on a preference prediction value predicted by the preference predictor in response to the candidate process recipes.

2. The method of claim 1, wherein the pre-trained process result predictor comprises a trained physical property prediction model to predict the target physical properties corresponding to the candidate process recipes, based on the pieces of recipe data.

3. The method of claim 1, wherein the collecting of the preference data comprises:
selecting the arbitrary process recipe pairs from process recipes having target physical properties above a predetermined reference according to the prediction result of the pre-trained process result predictor in an entire search interval of the candidate process recipes; and
collecting the preference data based on the selected arbitrary process recipe pairs.

4. The method of claim 3, wherein the selecting of the arbitrary process recipe pairs comprises:
filtering candidate process recipes predicted to have a score that is higher than a predetermined reference in the entire search interval corresponding to the target physical properties predicted by the pre-trained process result predictor; and
sampling the selected arbitrary process recipe pairs from among the filtered candidate process recipes.

5. The method of claim 3, wherein the collecting of the preference data comprises collecting, among the selected arbitrary process recipe pairs, one process recipe selected as the preference data.

6. The method of claim 1, wherein the target process comprises a thin film deposition process.

7. The method of claim 1, wherein the recommending of the target process recipe comprises:
specifying search intervals of the process recipe by considering a valid interval of the target physical properties and process parameters;
excluding a constraint area corresponding to a predetermined condition in an entire search interval of the candidate process recipes, based on data distribution and a normalization range of the process parameters corresponding to the search intervals of the process recipe; and
determining the target process recipe based on remaining search intervals other than the constraint area in the entire search interval.

8. The method of claim 1, wherein the recommending of the target process recipe comprises determining the target process recipe based on a score function that indicates a degree to which the target physical properties match physical properties predicted for labels by the pre-trained process result predictor.

9. The method of claim 8, wherein the determining of the target process recipe comprises:
converting a degree to which each of physical property numerical values predicted by the pre-trained process result predictor is close to a numerical value of the target physical properties into quality scores, using the score function; and
determining the target process recipe based on the converted quality scores.

10. The method of claim 1, wherein the recommending of the target process recipe comprises:
adjusting a reflection ratio between the target physical properties and the preference prediction value; and
recommending, among the candidate process recipes, the target process recipe for the target process according to the adjusted reflection ratio.

11. The method of claim 1, wherein the pieces of recipe data comprise of:
process conditions comprising a catalyst and a wafer size; or
process parameters that are sequentially controlled during the target process.

12. The method of claim 11, wherein the process conditions have a predetermined search interval and comprise a plurality of detailed conditions having two or more valid categories.

13. A training method of a process result predictor, the training method comprising:
preprocessing pieces of recipe data received to train the process result predictor; and
training the process result predictor using the pieces of preprocessed recipe data.

14. The training method of claim 13, wherein the preprocessing of the pieces of recipe data comprises filtering, from among the pieces of recipe data, at least one of recipe data having a valid physical property numerical value or recipe data in an unstandardized form.

15. The training method of claim 13, wherein the preprocessing of the pieces of recipe data comprises quantifying and normalizing, in a vector form, a process and physical properties corresponding to the pieces of recipe data.

16. The training method of claim 13, wherein the preprocessing of the pieces of recipe data comprises quantifying the pieces of recipe data in a vector form by tokenizing the pieces of recipe data into identifiers for each process condition.

17. The training method of claim 13, wherein the training of the process result predictor comprises training, among the preprocessed pieces of recipe data, the process result predictor by inputting process parameters used in a control process of a material synthesis environment to the process result predictor.

18. The training method of claim 13, wherein the training of the process result predictor comprises training the process result predictor to predict a range expected for each physical property numerical value as normal distribution to predict physical property numerical values measured at various locations for each process recipe.

19. The training method of claim 13, wherein the training of the process result predictor comprises training the process result predictor using maximum likelihood loss for output normal distribution of the process result predictor.

20. An apparatus for recommending a process recipe, the apparatus comprising:
one or more processors; and
a memory storing instructions configured to cause the one or more processors to:
select candidate process recipes for material synthesis corresponding to target physical properties based on a prediction result of a pre-trained process result predictor based on pieces of recipe data corresponding to a target process;
collect preference data of an expert for arbitrary process recipe pairs selected from among the candidate process recipes;
train a preference predictor to predict preference for the arbitrary process recipe pairs, using the preference data; and
recommend, among the candidate process recipes, a target process recipe for the target process, based on the target physical properties predicted by the pre-trained process result predictor and a preference prediction value predicted by the preference predictor in response to the candidate process recipes.
